(19) United States
(12) Patent Application Publication
(10) Pub. No.: US 2024/0389169 A1
(43) Pub. Date: Nov. 21, 2024

(54) MICROSERVICE-BASED ACCESS TO WIRELESS COMMUNICATION SYSTEMS

(71) Applicant: T-MOBILE INNOVATIONS LLC, Overland Park, KS (US)

(72) Inventors: Marouane Balmakhtar, Fairfax, VA (US); Lyle Walter Paczkowski, Mission Hills, KS (US); Mark Richard Bales, Lee’s Summit, MO (US); Robert Keith Butler, Overland Park, KS (US)

(21) Appl. No.: 18/319,867

(22) Filed: May 18, 2023

(51) Int. Cl. H04W 76/11; H04W 12/71

(52) U.S. Cl. CPC H04W 76/11; H04W 12/71

(57) ABSTRACT

A wireless communication device accesses a wireless communication network. The wireless communication device identifies an application identifier. The wireless communication device calls an Application Programming Interface (API) with the application identifier to identify a microservice API. The wireless communication device calls the microservice API to identify a hardware identifier. The wireless communication device transfers the hardware identifier to obtain access to the wireless communication network.

### TECHNICAL BACKGROUND

Wireless communication systems provide wireless data services to wireless communication devices like phones, computers, and other devices. The wireless data services may include internet-access, messaging, conferencing, or some other functionality. The wireless communication systems comprise network elements like wireless access nodes, access and mobility management functions, and user-plane functions.

The wireless communication devices comprise radio circuitry and processing circuitry. The radio circuitry that has antennas, modulation, digital signal processors, and the like. The processing circuitry has central processing units, memories, and other components. In the processing circuitry, the central processing units retrieve software from the memories and execute the software to drive device operations. The software typically includes operating systems, applications, libraries, and utilities.

Hypertext Transfer Protocol (HTTP) comprises an application layer protocol for distributed data. HTTP uses hyperlinks that enable a user to access related data through a mouse click or screen tap on the hyperlinks. HTTP is described in Internet Engineering Task Force (IETF) Request For Comment (RFC) 9114. Java Script Object Notation (JSON) comprises a data exchange format that transmits data objects using human-readable text. JSON is often used by web servers and user applications to exchange data. JSON is described in IETF Internet Standard 90 RFC 8259. JSON Linking Data (LD) comprises structured data that is dynamically linked to other data through HTTP hyperlinks. JSON-LD comprises a lightweight linked data format that provides context. Humans may readily read and write JSON-LD, and machines can readily parse and generate JSON-LD. JSON-LD includes a vocabulary and semantics for functions like create, read, update, and delete.

The wireless communication devices execute the applications to perform various functions. The applications have Application Programming Interfaces (APIs) that are called to invoke the functions. Some APIs in the wireless communication devices comprise microservice APIs. Microservice APIs use a hypermedia format. Hypermedia comprises interactive information like hyperlinks. In addition to text hyperlinks, hypermedia may comprise interactive graphics, audio, and video.

Microservice APIs are a subset of JSON-LD. Microservice APIs limit JSON-LD by not using processing algorithms. Microservice APIs introduce an API vocabulary that includes “ID”, “meta”, “query”, “operate”, “error”, and “isarray”. The “ID” string comprises a unique value used for identifying resources like the primary key in a database. The “meta” object comprises any information. The “query” object comprises container for showing information about the current query. The “operate” object is used for application-specific operations to update resources. The “error” object returns an error in the payload of a response to a failed request.

Microservice APIs conform to the Representation State Transfer (REST) API architecture. REST APIs are used for stateless client-server communications. REST APIs feature a uniform interface that identifies resources and application states with hypermedia. REST APIs return hypermedia to all available resources, so the client does not need information about the server configuration. REST APIs manipulate resources through representations that have the information needed to change resource states. REST APIs use self-descriptive messaging that describes how to process their messages.

Unfortunately, wireless communication devices use cumbersome authentication processing algorithms to access wireless communication networks. Moreover, the wireless communication devices do not effectively and efficiently use microservice APIs to securely access the wireless communication networks.

### TECHNICAL OVERVIEW

In some examples, a wireless communication device accesses a wireless communication network as follows. An application identifier is identified. An Application Programming Interface (API) is called with the application identifier to identify a microservice API. The microservice API is called to identify a hardware identifier. The hardware identifier is transferred to obtain access to the wireless communication network.

In some examples, a wireless communication device obtains access to a wireless communication network. In the wireless communication device, radio circuitry wirelessly receives an application identifier. In the wireless communication device, processing circuitry calls a Representation State Transfer (REST) API with the application identifier to identify a microservice API. The processing circuitry calls the microservice API to identify a hardware identifier. The radio circuitry wirelessly transfers the hardware identifier to obtain access to the wireless communication network.

In some examples, a wireless communication device obtains access to a wireless communication network. In the wireless communication device, radio circuitry to wirelessly receives a Hypertext Transfer Protocol (HTTP) request that indicates an application identifier. In the wireless communication device, processing circuitry calls a REST API with the application identifier to identify a microservice API. The processing circuitry calls the microservice API to identify a hardware identifier. The radio circuitry wirelessly transfers an HTTP response that indicates the hardware identifier to obtain access to the wireless communication network.

### DESCRIPTION OF THE DRAWINGS

FIG. 1 illustrates an exemplary wireless communication system that has a wireless communication device that obtains access to a wireless communication network.

FIG. 2 illustrates an exemplary operation of the wireless communication system that has the wireless communication device to obtain access to the wireless communication network.

FIG. 3 illustrates an exemplary operation of the wireless communication system that has the wireless communication device to obtain access to the wireless communication network.

FIG. 4 illustrates an exemplary wireless communication system that has a wireless User Equipment (UE) that obtains access to a Third Generation Partnership Project (3GPP) network.

FIG. 5 illustrates an exemplary User Equipment (UE) in the wireless communication system.

FIG. 6 illustrates an exemplary Wireless Fidelity (WIFI) access node in the wireless communication system.

FIG. 7 illustrates an exemplary Fifth Generation New Radio (5GNR) access node in the wireless communication system.

FIG. 8 illustrates an exemplary data center in the wireless communication system.

FIG. 9 illustrates an exemplary operation of the wireless UE to obtain access to the 3GPP network.

FIG. 10 illustrates an exemplary operation of the wireless communication system that has the wireless UE that obtains access to the 3GPP network.

FIG. 11 illustrates an exemplary operation of the wireless communication system that has the wireless UE that obtains access to the 3GPP network.

FIG. 12 illustrates an exemplary operation of the wireless communication system that has the wireless UE that obtains access to a non-3GPP Interworking Function.

FIG. 13 illustrates an exemplary operation of the wireless communication system that has the wireless UE that obtains access to the 3GPP network.

FIG. 14 illustrates an exemplary operation of the wireless communication system that has the wireless UE that obtains access to a to a non-3GPP Interworking Function.

### DETAILED DESCRIPTION

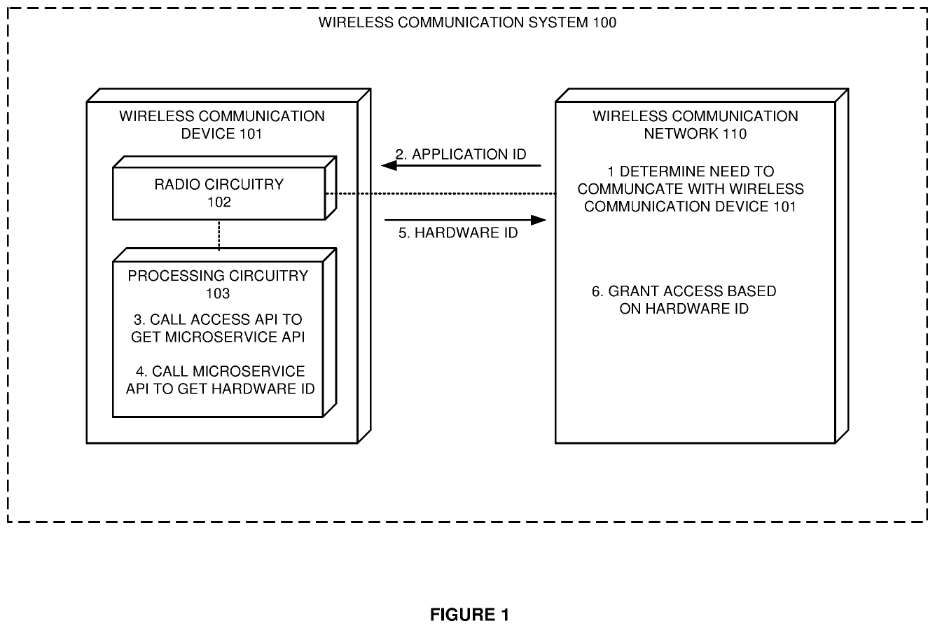

FIG. 1 illustrates exemplary wireless communication system 100 that has wireless communication device 101 to obtain access to wireless communication network 110. Wireless communication system 100 comprises wireless communication device 101 and wireless communication network 110. Wireless communication device 101 comprises a phone, computer, sensor, or some other apparatus with wireless communication circuitry. Wireless communication network 110 comprises a Wireless Fidelity (WIFI) network, Third Generation Partnership Project (3GPP) network, satellite network, and/or or some other data communication network with wireless communication circuitry. For clarity, the amount of wireless communication devices and wireless communication networks that are shown on FIG. 1 has been restricted.

Wireless communication device 101 executes applications to perform various functions. The applications have Application Programming Interfaces (APIs) that are called to invoke the functions. Some APIs in wireless communication device 101 comprise microservice APIs. Microservice APIs use a hypermedia format. Hypermedia comprises interactive information like hyperlinks. In addition to text hyperlinks, hypermedia may comprise interactive graphics, audio, and video.

Various examples of system operation and configuration are described herein. In some examples, wireless communication device 101 obtains access to wireless communication network 110 as follows. In a first operation, wireless communication network 110 determines a need to communicate with wireless communication device 101. The determination could be made in response to an access request from wireless communication device 101 or some other criteria. In a second operation, wireless communication network 110 wirelessly transfers an application Identifier (ID) to radio circuitry 102 in wireless communication device 101. Radio circuitry 102 transfers the application ID to processing circuitry 103. In a third operation, processing circuitry 103 calls an access API with the application ID to determine a microservice API. The access API may comprise a Representation State Transfer (REST) API. In a fourth operation, processing circuitry 103 calls the microservice API to determine a hardware ID, and processing circuitry 103 transfers the hardware ID to radio circuitry 102. The hardware ID could be a device ID, manufacturer device ID, processing circuitry ID, radio circuitry ID, or some other apparatus indicator. In a fifth operation, radio circuitry 102 wirelessly transfers the hardware ID to wireless communication network 110. In a sixth operation, wireless communication network 110 grants network access to wireless communication device 101 based on the hardware ID. For example, wireless communication network 110 may compare the radio circuitry ID from wireless communication device 101 with a copy of the radio circuitry ID that is stored in network 110. After the access grant, wireless communication device 101 may communicate over wireless communication network 110.

In some examples, processing circuitry 103 calls multiple microservice APIs based on the access API response to obtain multiple hardware IDs that are used together to obtain network access. In some examples, processing circuitry 103 calls a microservice API to determine a software ID. Processing circuitry 103 transfers the software ID to radio circuitry 102. The software ID could be an operating system ID, library ID, or some other computer instruction indicator. Wireless communication device 101 transfers the software ID along with the hardware ID to wireless communication network 110. Wireless communication network 110 uses the software ID along with the hardware ID to grant network access. Processing circuitry 103 may call multiple microservice APIs to obtain multiple software IDs that are used together with one or more hardware IDs to obtain network access.

Wireless communication device 101 may receive the application ID from wireless communication network 110 in various ways. For example, wireless communication device 101 may receive the application ID in a Hypertext Transfer Protocol (HTTP) request from a Wireless Fidelity (WIFI) access node. Wireless communication device 101 may receive the application ID in an HTTP request from an Interworking Function (IWF) over a WIFI access node and an Internet Protocol (IP) network. Wireless communication device 101 may receive the application ID in an HTTP request from an Access and Mobility Function (AMF) over a WIFI access node, IP network, and IWF. The HTTP request from the AMF may be transported to wireless communication device 101 in a Non-Access Stratum (NAS) message that traverses a 5GNR access node or that traverses over an IWF, IP network, and WIFI access node.

Wireless communication device 101 may transfer the hardware/software IDs to wireless communication network 110 in various ways. For example, wireless communication device 101 may transfer the IDs to a WIFI access node in an HTTP response. Wireless communication device 101 may transfer the IDs to an IWF in an HTTP response over a WIFI access node and the IP network. Wireless communication device 101 may transfer the IDs to an AMF in an HTTP response over a WIFI access node, IP network, and IWF. The HTTP response from wireless communication device 101 to the AMF may be transported in a NAS message that traverses a 5GNR access node or that traverses a WIFI access node, IP network, and IWF. Wireless communication device 101 may transfer the IDs to an AMF in an HTTP response that is transported in an RRC set-up complete message that a 5GNR access node converts into an initial UE message. Wireless communication device 101 may transfer the IDs to a 5GNR access node in an HTTP response that is transported by an RRC set-up complete message.

Wireless communication device 101 comprises one or more radios that wirelessly communicate using wireless protocols like WIFI (Institute of Electrical and Electronics Engineers 802.11), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and Sixth Generation (6G) satellite communications. Wireless communication network 110 comprises network elements like wireless access nodes, interworking functions, access and mobility management functions, uniform data management, session management functions, user-plane functions, and/or some other type of data communication apparatus. Wireless communication device 101 and network 110 comprise microprocessors, software, memories, transceivers, bus circuitry, and/or some other data processing components, The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of wireless communication system 100 as described herein. Thus, wireless communication device 101 and wireless communication network 110 comprise data processing circuitry and non-transitory, machine-readable storage media that stores processing instructions that direct the data processing circuitry to perform the methods described herein.

HTTP comprises an application layer protocol for distributed data. HTTP uses hyperlinks that enable a user to access related data through a mouse click or screen tap on the hyperlinks. HTTP is described in Internet Engineering Task Force (IETF) Request For Comment (RFC) 9114.

Java Script Object Notation (JSON) comprises a data exchange format that transmits data objects using human-readable text. JSON is often used by web servers and user applications to exchange data. JSON is described in IETF Internet Standard 90 RFC 8259. JSON Linking Data (LD) comprises structured data that is dynamically linked to other data through HTTP hyperlinks. JSON-LD comprises a lightweight linked data format that provides context. Humans may readily read and write JSON-LD, and machines can readily parse and generate JSON-LD. JSON-LD includes a vocabulary and semantics for functions like create, read, update, and delete.

Microservice APIs are a subset of JSON-LD. Microservice APIs limit JSON-LD by not using processing algorithms. Microservice APIs introduce an API vocabulary that includes “ID”, “meta”, “query”, “operate”, “error”, and “isarray”. The “ID” string comprises a unique value used for identifying resources like the primary key in a database. The “meta” object comprises any information. The “query” object comprises container for showing information about the current query. The “operate” object is used for application-specific operations to update resources. The “error” object returns an error in the payload of a response to a failed request.

Microservice APIs conform to the Representation State Transfer (REST) API architecture. REST APIs are used for stateless client-server communications. REST APIs feature a uniform interface that identifies resources and application states with hypermedia. REST APIs return hypermedia to all available resources, so the client does not need information about the server configuration. REST APIs manipulate resources through representations that have the information needed to change resource states. REST APIs use self-descriptive messaging that describes how to process their messages.

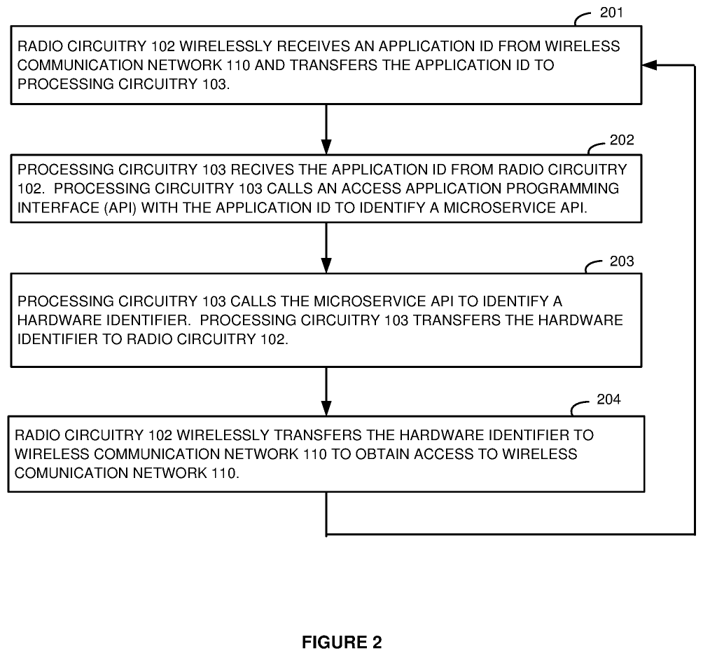

FIG. 2 illustrates an exemplary operation of wireless communication system 100 that has wireless communication device 101 that obtains access to wireless communication network 110. The operation may vary in other examples. Wireless communication device 101 receives an application ID from wireless communication network 110 and transfers the application ID to processing circuitry 103 (201). Processing circuitry 103 receives the application ID from radio circuitry 102 and calls an access API with the application ID to determine a microservice API (202). Processing circuitry 103 calls the microservice API to determine a hardware ID and transfers the hardware ID to radio circuitry 102 (203). Radio circuitry 102 receives the hardware ID and wirelessly transfers the hardware ID to wireless communication network 110 to obtain access to wireless communication network 110 (204). The operation may repeat (201).

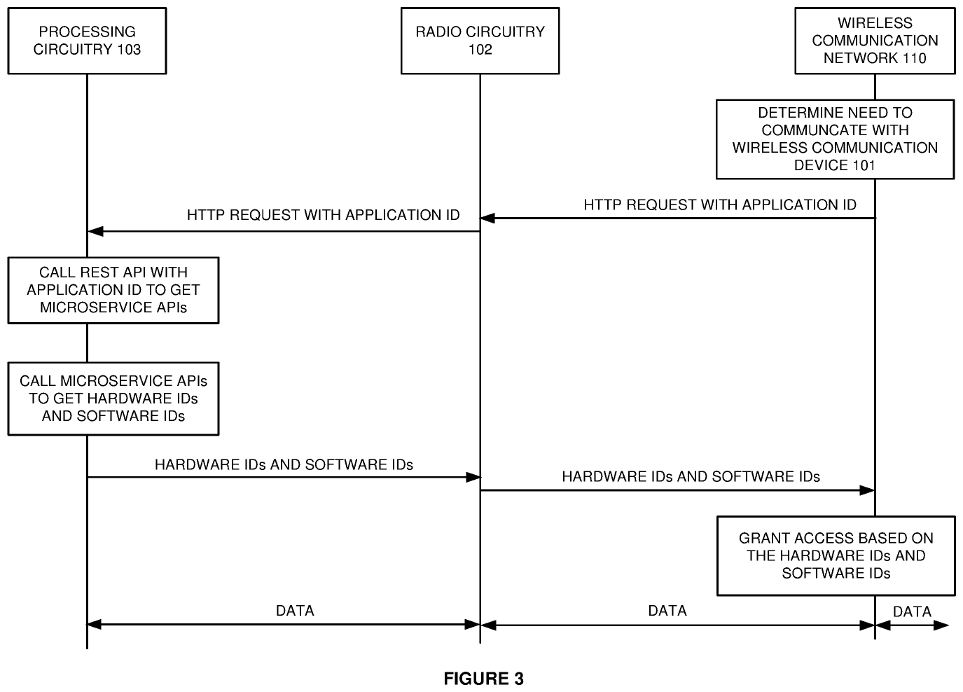

FIG. 3 illustrates an exemplary operation of wireless communication system 100 that has wireless communication device 101 that obtains access to wireless communication network 110. The operation may vary in other examples. Wireless communication network 110 determines the need to communicate with wireless communication device 101, and in response, wirelessly transfers an HTTP request having an application ID to radio circuitry 102. Radio circuitry 102 transfers the HTTP request with the application ID to processing circuitry 103. In response to the HTTP request, processing circuitry 103 calls a REST API with the application ID to determine multiple microservice APIs. Processing circuitry 103 calls the microservice APIs to determine hardware IDs and software IDs. Processing circuitry 103 transfers an HTTP response having the hardware IDs and software IDs to radio circuitry 102. Radio circuitry 102 wirelessly transfers the HTTP response having the hardware IDs and software IDs to wireless communication network 110. Wireless communication network 110 grants network access to wireless communication device 101 based on the hardware IDs and software IDs. For example, wireless communication network 110 may compare the hardware and software IDs to a set of known IDs that are maintained in network 110. After the access grant, processing circuitry 103 exchanges data with radio circuitry 102, and radio circuitry 102 wirelessly exchanges the data with a data communication device (not shown) like an internet router, enterprise server, or some other data apparatus over wireless communication network 110.

Advantageously, wireless communication device 101 obtains network access to wireless communication network 110 without using cumbersome and costly authentication algorithms. Moreover, wireless communication system 100 efficiently and effectively uses microservice APIs to securely access wireless communication network 110.

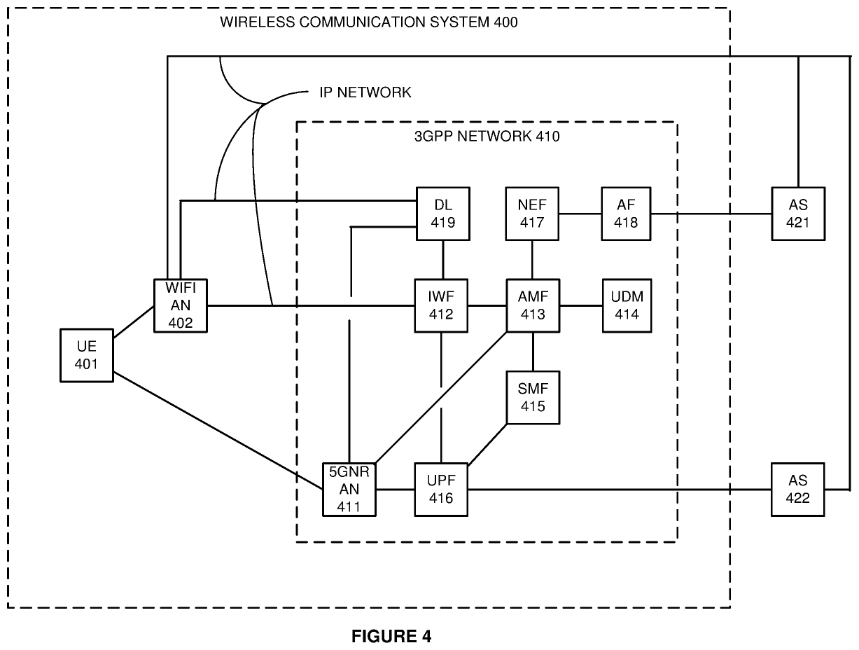

FIG. 4 illustrates exemplary wireless communication system 400 that has wireless User Equipment (UE) 401 that obtains access Third Generation Partnership Project (3GPP) network 410. Wireless communication system 400 comprises an example of wireless communication system 100, although wireless communication system 100 may differ. 3GPP network 410 comprises an example of wireless communication network 110, although wireless communication network 110 may differ. Wireless communication system 400 comprises UE 401, WIFI Access Node (AN) 402, and Application Servers (AS) 421-422. 3GPP network comprises 5GNR AN 411, Interworking Function (IWF) 412, Access and Mobility Management Function (AMF) 413, User Data Management (UDM) 414, Session Management Function (SMF) 415, User Plane Function (UPF) 416, Network Exposure Function (NEF) 417, Application Function (AF) 418, and Distributed Ledger Node (DL) 419. IWF 412 comprises a gateway between non-3GPP access networks and a 5G core network. The above components of wireless communication system 400 comprise data processing circuitry and non-transitory, machine-readable storage media that stores processing instructions that direct the data processing circuitry to perform the methods described herein.

Various techniques for UE 401 to access 3GPP network 410 are described below. In a first example, UE 401 transfers an access request to WIFI AN 402. In response to the access request, WIFI AN 402 transfers an HTTP request with an application ID to UE 401. In response to the HTTP request, UE 401 calls a REST API with the application ID. The REST API returns various microservice APIs. UE 401 calls the microservice APIs, and the microservice APIs return hardware IDs and software IDs. The microservice APIs may also return resource states and random numbers. The hardware IDs may comprise CPU IDs, radio IDs, device IDs, or some other hardware identifying data. The software IDs may comprise operating system IDs, library IDs, version numbers, or some other software identifying data. UE 401 transfers the hardware IDs and software IDs in an HTTP response to WIFI AN 402. UE 401 may encrypt the HTTP response using a public key for 3GPP network 410. WIFI AN 402 transfers the hardware IDs and software IDs to DL 419. DL 419 may decrypt the HTTP response using a private key for 3GPP network 410. DL 419 executes a smart contract with the hardware IDs and software IDs to authenticate and authorize UE 401. DL 419 may compare the hardware IDs and software IDs to known values for these IDs that are maintained in 3GPP network 410 to perform the authentication and authorization. DL 419 reaches a consensus on the authentication and authorization and instructs WIFI AN 402 that UE 401 is authenticated and authorized for service. WIFI AN 402 may then provide UE 401 with access to AS 421-422 over an Internet Protocol (IP) network.

Alternatively, WIFI AN 402 may signal IWF 412 that UE 401 is authenticated and authorized for service, and IWF 412 may signal the same to AMF 413. AMF 413 may then establish a data session for UE 401. AMF 413 may retrieve UE context for UE 401 from UDM 414 and transfer the UE context to SMF 415 for additional context development. AMF 413 transfers the UE context to IWF 412, and SMF 415 transfers the UE context to UPF 416. UE may then communicate with AS 422 over WIFI AN 402, IP network, IWF 412, and UPF 416. AMF 413 may establish an N1 link with UE 401 over IWF 412, IP network, and WIFI AN 402 and exchange data messages with UE 401 over the N1 link. AMF 413 may exchange these data messages with AS 421 over NEF 417 and AF 418.

In a second example, UE 401 transfers an access request to 5GNR AN 411—possibly in a Radio Resource Control (RRC) set-up request. In response to the access request, 5GNR AN 411 transfers an application ID to UE 401—possibly in an HTTP request that is transported in an RRC set-up response. In response to the HTTP request, UE 401 calls a REST API with the application ID. The REST API returns various microservice APIs. UE 401 calls the microservice APIs, and the microservice APIs return hardware IDs and software IDs. The microservice APIs may also return resource states and random numbers. The hardware IDs may comprise CPU IDs, radio IDs, device IDs, or some other hardware identifying data. The software IDs may comprise operating system IDs, library IDs, version numbers, or some other software identifying data. UE 401 transfers the hardware IDs and software IDs to 5GNR AN 411—possibly in an RRC set-up complete message that transports an HTTP response. UE 401 may encrypt the HTTP response using a public key for 3GPP network 410. 5GNR AN 411 transfers the hardware IDs and software IDs to DL 419. DL 419 may decrypt the HTTP response using a private key for 3GPP network 410. DL 419 executes a smart contract with the hardware IDs and software IDs to authenticate and authorize UE 401. DL 419 may compare the hardware IDs and software IDs to known values for these IDs that are maintained in 3GPP network 410 to perform the authentication and authorization. DL 419 reaches a consensus on the authentication and authorization and instructs 5GNR AN 411 that UE 401 is authenticated and authorized for service. 5GNR AN 411 then signals AMF 413 that UE 401 is authenticated and authorized for service, and AMF 413 establishes a data session for UE 401.

To establish the data session, AMF 413 may retrieve UE context for UE 401 from UDM 414 and transfer the UE context to SMF 415 for additional context development. AMF 413 transfers the UE context to 5GNR AN 411, and SMF 415 transfers the UE context to UPF 416. UE 401 may then communicate with AS 422 over 5GNR AN 411 and UPF 416. AMF 413 may establish an N1 link with UE 401 over 5GNR AN 411 and exchange data messages with UE 401 over the N1 link. AMF 413 may exchange these data messages with AS 421 over NEF 417 and AF 418.

In a third example, UE 401 transfers an access request to IWF 412 over WIFI AN 402 and the IP network. In response to the access request, IWF 412 transfers an HTTP request with an application ID to UE 401 over the IP network and WIFI AN 402. In response to the HTTP request, UE 401 calls a REST API with the application ID. The REST API returns various microservice APIs. UE 401 calls the microservice APIs, and the microservice APIs return hardware IDs and software IDs. The microservice APIs may also return resource states and random numbers. The hardware IDs may comprise CPU IDs, radio IDs, device IDs, or some other hardware identifying data. The software IDs may comprise operating system IDs, library IDs, version numbers, or some other software identifying data. UE 401 transfers the hardware IDs and software IDs in an HTTP response to IWF 412 over WIFI AN 402 and the IP network. UE 401 may encrypt the HTTP request using a public key for 3GPP network 410. IWF 412 transfers the hardware IDs and software IDs to DL 419. DL 419 may decrypt the HTTP response using a private key for 3GPP network 410. DL 419 executes a smart contract with the hardware IDs and software IDs to authenticate and authorize UE 401. DL 419 may compare the hardware IDs and software IDs to known values for these IDs that are maintained in 3GPP network 410 to perform the authentication and authorization. DL 419 reaches a consensus on the authentication and authorization and instructs IWF 412 that UE 401 is authenticated and authorized for service. IWF 412 then signals AMF 413 that UE 401 is authenticated and authorized for service, and AMF 413 establishes a data session for UE 401.

To establish the data session, AMF 413 may retrieve UE context for UE 401 from UDM 414 and transfer the UE context to SMF 415 for additional context development. AMF 413 transfers the UE context to IWF 412, and SMF 415 transfers the UE context to UPF 416. UE 401 may then communicate with AS 422 over WIFI AN 402, the IP network, IWF 412, and UPF 416. AMF 413 may establish an N1 link with UE 401 over IWF 412, the IP network, and WIFI AN 402 and exchange data messages with UE 401 over the N1 link. AMF 413 may exchange these data messages with AS 421 over NEF 417 and AF 418.

In a fourth example, UE 401 transfers an access request to AMF 413 over WIFI AN 402, the IP network, and IWF 412. In response to the access request, AMF 413 transfers an HTTP request with an application ID to UE 401 over IWF 412, the IP network, and WIFI AN 402. In response to the HTTP request, UE 401 calls a REST API with the application ID. The REST API returns various microservice APIs. UE 401 calls the microservice APIs, and the microservice APIs return hardware IDs and software IDs. The microservice APIs may also return resource states and random numbers. The hardware IDs may comprise CPU IDs, radio IDs, device IDs, or some other hardware identifying data. The software IDs may comprise operating system IDs, library IDs, version numbers, or some other software identifying data. UE 401 transfers the hardware IDs and software IDs in an HTTP response to AMF 413 over WIFI AN 402, the IP network, and IWF 412. UE 401 may encrypt the HTTP response using a public key for 3GPP network 410. AMF 413 transfers the hardware IDs and software IDs to UDM 414. UDM 414 may decrypt the HTTP response using a private key for 3GPP network 410. UDM 414 authenticates and authorizes UE 401 based on the hardware IDs and software IDs. For example, UDM 414 may compare the hardware IDs and software IDs to known values for these IDs that are maintained in 3GPP network 410. UDM 414 may be configured with a distributed ledger node that authenticates and authorizes UE 401 in the manner of DL 419. UDM 414 instructs AMF 413 that UE 401 is authenticated and authorized for service. AMF 413 then establishes a data session for UE 401.

To establish the data session, AMF 413 may retrieve UE context for UE 401 from UDM 414 and transfer the UE context to SMF 415 for additional context development. AMF 413 transfers the UE context to IWF 412, and SMF 415 transfers the UE context to UPF 416. UE 401 may then communicate with AS 422 over WIFI AN 402, the IP network, IWF 412, and UPF 416. AMF 413 may establish an N1 link with UE 401 over IWF 412, the IP network, and WIFI AN 402 and exchange data messages with UE 401 over the N1 link. AMF 413 may exchange these data messages with AS 421 over NEF 417 and AF 418.

In a fifth example, UE 401 transfers an access request to AMF 413 over 5GNR AN 411—possibly in an RRC set-up complete message that 5GNR AN 411 converts into an initial UE message. Alternatively, UE 401 may transfer the access request to AMF 413 over 5GNR AN 411 a Non-Access Stratum (NAS) message. In response to the access request, AMF 413 transfers an application ID to UE 401 over 5GNR AN 411—possibly in a NAS message that transports an HTTP message. In response to the HTTP message, UE 401 calls a REST API with the application ID. The REST API returns various microservice APIs. UE 401 calls the microservice APIs, and the microservice APIs return hardware IDs and software IDs. The microservice APIs may also return resource states and random numbers. The hardware IDs may comprise CPU IDs, radio IDs, device IDs, or some other hardware identifying data. The software IDs may comprise operating system IDs, library IDs, version numbers, or some other software identifying data. UE 401 transfers the hardware IDs and software IDs to AMF 413 over 5GNR AN 411—possibly in a NAS message that transports an HTTP response that has the IDs. UE 401 may encrypt the HTTP response using a public key for 3GPP network 410. AMF 413 transfers the hardware IDs and software IDs to UDM 414. UDM 414 may decrypt the HTTP response using a private key for 3GPP network 410. UDM 414 authenticates and authorizes UE 401 based on the hardware IDs and software IDs. For example, UDM 414 may compare the hardware IDs and software IDs to known values for these IDs that are maintained in 3GPP network 410. UDM 414 may be configured with a distributed ledger node to authenticate and authorize UE 401 in the manner of DL 419. UDM 414 instructs AMF 413 that UE 401 is authenticated and authorized for service. AMF 413 then establishes a data session for UE 401.

To establish the data session, AMF 413 may retrieve UE context for UE 401 from UDM 414 and transfer the UE context to SMF 415 for additional context development. AMF 413 transfers the UE context to 5GNR AN 411, and SMF 415 transfers the UE context to UPF 416. UE 401 may then communicate with AS 422 over 5GNR AN 411 and UPF 416. AMF 413 may establish an N1 link with UE 401 over 5GNR AN 413 and exchange data messages with UE 401 over the N1 link. AMF 413 may exchange these data messages with AS 421 over NEF 417 and AF 418.

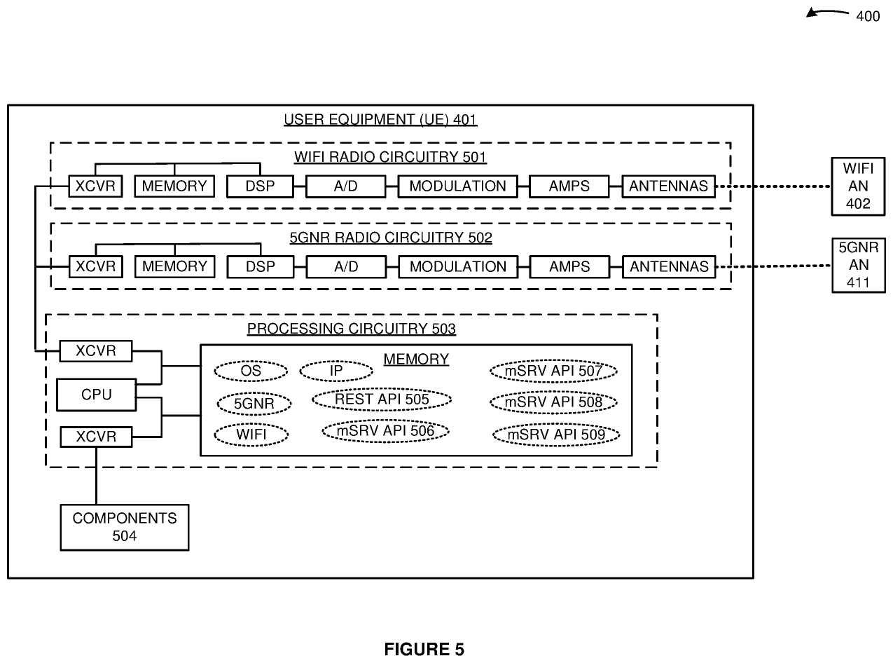

FIG. 5 illustrates exemplary User Equipment (UE) 401 in wireless communication system 400. UE 401 represents an example of wireless communication device 101, although device 101 may differ. UE 401 comprises WIFI radio circuitry 501, 5GNR radio circuitry 502, processing circuitry 503, and components 504. Components 504 comprise sensors, cameras, medical devices, and/or some other user apparatus. Radio circuitry 501-502 comprise antennas, amplifiers, filters, modulation, analog-to-digital interfaces, DSPs, memories, and transceivers (XCVRs) that are coupled over bus circuitry. Processing circuitry 503 comprises CPU, memory, and transceivers that are coupled over bus circuitry. The memory in processing circuitry 503 stores software like an Operating System (OS), 5GNR application (5GNR), WIFI application (WIFI), IP application (IP), Representation State Transfer (REST) Application Programming Interface (API) 505, and microservice APIs 506-509. The antennas in WIFI radio circuitry 501 exchange WIFI signals with WIFI AN 402. The antennas in 5GNR radio circuitry 502 exchange 5GNR signals with 5GNR AN 411. Transceivers in radio circuitry 501-502 are coupled to transceivers in processing circuitry 503. In processing circuitry 503, the CPU retrieves the software from the memory and executes the software to direct the operation of UE 401 as described herein.

In operation, processing circuitry 503 transfers an access request over WIFI radio circuitry 501 and WIFI AN 402, or over 5GNR radio circuitry 502 and 5GNR AN 411. Processing circuitry 503 may transfer the access request in an RRC set-up request, NAS message, or some other data communication. Processing circuitry 503 receives an HTTP request having an application ID over WIFI radio circuitry 501 and WIFI AN 402, or over 5GNR radio circuitry 502 and 5GNR AN 411. Processing circuitry 503 may receive the application ID in an HTTP request that is transported by an RRC set-up response, NAS message, or some other data communication. Processing circuitry 503 calls REST API 505 with the application ID in response to the HTTP request. In response to the API call, REST API 505 indicates microservice APIs 506-509 to processing circuitry 503. REST API 505 may have a data structure that translates the application ID into IDs for microservice APIs 505-509. Processing circuitry 503 individually calls microservice APIs 506-509, and in response, microservice APIs 506-509 indicate hardware IDs and software IDs. Microservice APIs 506-509 may also return resource states and random numbers. The hardware IDs and software IDs may comprise CPU IDs, radio IDs, device IDs, operating system IDs, library IDs, or some other identifying data. For example, microservice API 506 may return the serial number of the CPU in processing circuitry 503 when called. Microservice API 507 may return the identity and version of the OS in processing circuitry 503 when called. Microservice API 508 may return a resource state when called. Microservice API 509 may return a random number when called. Processing circuitry 503 transfers the hardware IDs and software IDs over WIFI radio circuitry 501 and WIFI AN 402 or over 5GNR radio circuitry 502 and 5GNR AN 411 to obtain authentication and authorization. Processing circuitry 503 may transfer the IDs—and possibly resource states and a random number—in an HTTP response that is transported by an RRC set-up complete message, NAS message, or some other data communication. Processing circuitry 503 may encrypt the HTTP response with a public key for 3GPP network 410.

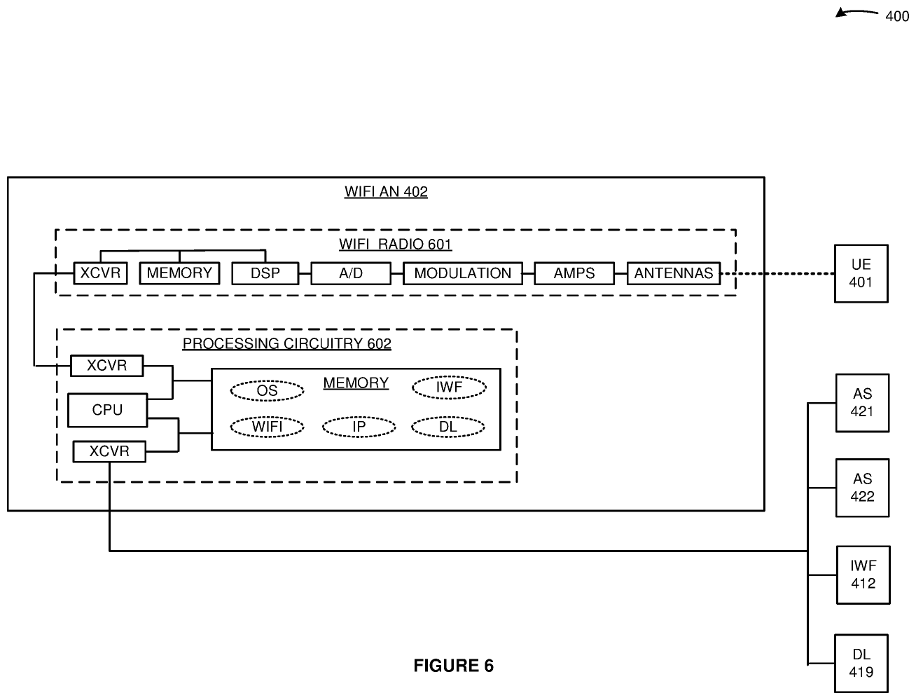

FIG. 6 illustrates exemplary Wireless Fidelity Access Node (WIFI AN) 402 in wireless communication system 400. WIFI AN 402 comprises an example of wireless communication network 110, although network 110 may differ. WIFI AN 402 comprises WIFI radio 601 and processing circuitry 602. Radio 601 comprises antennas, amplifiers, filters, modulation, analog-to-digital interfaces, DSPs, memories, and transceivers (XCVRs) that are coupled over bus circuitry. Processing circuitry 602 comprises CPU, memory, and transceivers that are coupled over bus circuitry. The memory in processing circuitry 602 stores software like an Operating System (OS), WIFI application (WIFI), IP application (IP), IWF interface (IWF), and Distributed Ledger interface (DL). The antennas in WIFI radio 601 exchange WIFI signals with UE 401. Transceivers in radio 601 are coupled to transceivers in processing circuitry 602. Transceivers in processing circuitry 602 are coupled to transceivers in IWF 412, DL 419, and AS 421-422. In processing circuitry 602, the CPU retrieves the software from the memory and executes the software to direct the operation of WIFI AN 402 as described herein.

In operation, processing circuitry 602 transfers an application ID to UE 401 over WIFI radio 601. Processing circuitry 602 may transfer the application ID in an HTTP request that is transported by NAS messages or some other data communication. In response, processing circuitry 602 receives hardware and software IDs from UE 401 over WIFI radio 601. Processing circuitry 602 may receive the IDs in an HTTP response that is transported in a NAS message or some other data communication. Processing circuitry 602 transfers these IDs to IWF 412 or DL 419 for authentication and authorization. Processing circuitry 602 may transfer the IDs in an HTTP response that is transported in a NAS message or some other data communication. When processing circuitry 602 receives a subsequent authentication and authorization for UE 401, processing circuitry 602 exchanges user data over WIFI radio 601 between UE 401 and AS 421-422 or IWF 412.

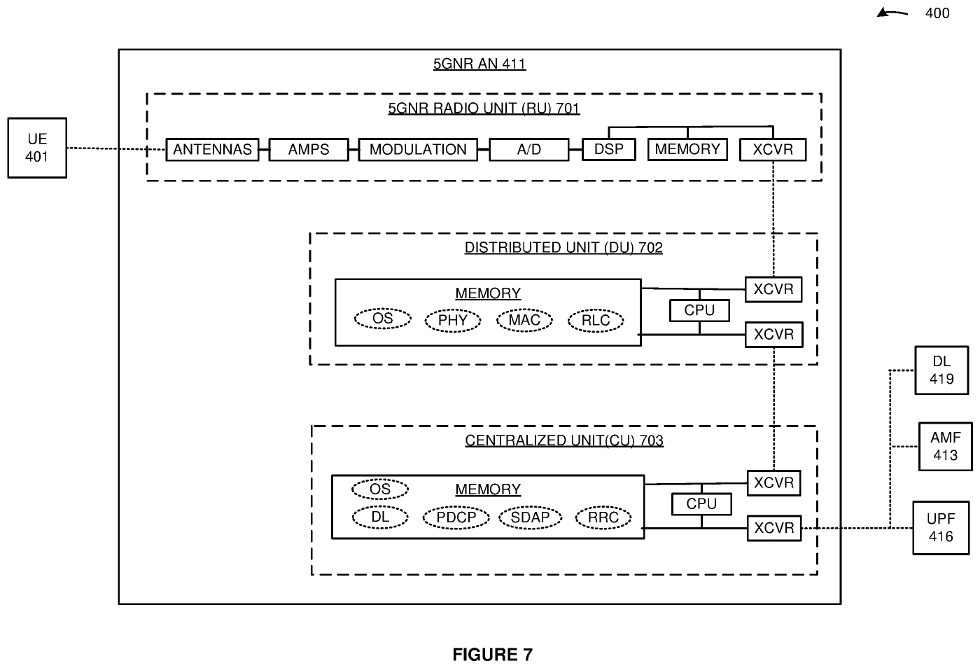

FIG. 7 illustrates exemplary Fifth Generation New Radio Access Node (5GNR AN) 411 in wireless communication system 400. 5GNR AN 411 comprises an example of wireless communication network 110, although network may differ. 5GNR AN 411 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. DU 702 comprises memory, CPU, user interfaces and components, and transceivers that are coupled over bus circuitry. The memory in DU 702 stores operating system and 5GNR network applications for Physical Layer (PHY), Media Access Control (MAC), and Radio Link Control (RLC). CU 703 comprises memory, CPU, and transceivers that are coupled over bus circuitry. The memory in CU 703 stores an operating system and 5GNR network applications for Distributed Ledger interface (DL), Packet Data Convergence Protocol (PDCP), Service Data Adaption Protocol (SDAP), and Radio Resource Control (RRC). The antennas in 5GNR RU 701 are wirelessly coupled to UE 401 over 5GNR links. Transceivers in 5GNR RU 701 are coupled to transceivers in DU 702. Transceivers in DU 702 are coupled to transceivers in CU 703. Transceivers in CU 703 are coupled AMF 413, UPF 416, and DL 419. The DSP and CPU in RU 701, DU 702, and CU 703 execute the radio applications, operating systems, and network applications to exchange data and signaling with UE 401, AMF 413, UPF 416, and DL 419 as described herein.

In operation, CU 703 transfers an application ID to UE 401 over DU 702 and RU 701. CU 703 may transfer the application ID in an HTTP request that is transported in an RRC message, NAS message, or some other data communication. For example, 5GNR AN 411 may transfer the HTTP message having the application ID to UE 401 in an RRC set-up response. CU 703 receives the hardware IDs and software IDs from UE 401 over RU 701 and DU 702. CU 703 may receive the IDs in an HTTP response that is transported in an RRC message, NAS message, or some other data communication. CU 703 transfers these IDs to AMF 413 or DL 419 for authentication and authorization. Processing circuitry 602 may transfer IDs in an HTTP response that is transported by a NAS messages or some other data communication. For example, 5GNR AN 411 may receive the HTTP response having the IDs from UE 401 in an RRC set-up complete message and transfer HTTP response having the IDs to AMF 413 an initial UE message. When CU 703 receives a subsequent authentication and authorization for UE 401, 5GNR AN 411 exchanges user data over RU 701, DU 702, and CU 703 between UE 401 and UPF 416.

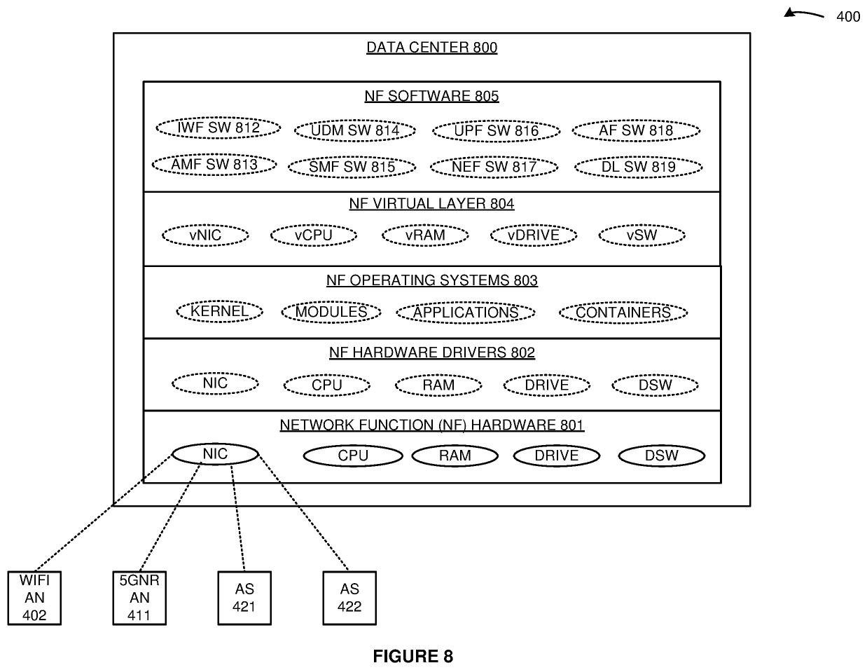

FIG. 8 illustrates exemplary data center 800 in wireless communication system 400. Data center 800 comprises an example of wireless communication network 110, although network 110 may differ. Data center 800 comprises NF hardware 801, NF hardware drivers 802, NF operating systems 803, NF virtual layer 804, and NF Software (SW) 805. NF hardware 801 comprises Network Interface Cards (NICs), CPU, RAM, Flash/Disk Drives (DRIVE), and Data Switches (DSW). NF hardware drivers 802 comprise software that is resident in the NIC, CPU, RAM, DRIVE, and DSW. NF operating systems 803 comprise kernels, modules, applications, and containers. NF virtual layer 804 comprises vNIC, vCPU, vRAM, vDRIVE, and vSW. NF SW 805 comprises IWF SW 812, AMF SW 813, UDM SW 814, SMF SW 815, UPF SW 816, NEF SW 817, AF SW 818, and DL SW 819. The NIC in NF hardware 801 are coupled to WIFI AN 402, 5GNR AN 411, and AS 421-422. NF hardware 801 executes NF hardware drivers 802, NF operating systems 803, NF virtual layer 804, and NF SW 805 to form and operate IWF 412, AMF 413, UDM 414, SMF 415, UPF 416, NEF 417, AF 418, and DL 419. Network data center 800 may be located at a single site or be distributed across multiple geographic locations.

In some examples, IWF SW 812 receives an access request from UE 401 over WIFI AN 402 and the IP network. In response to the access request, IWF SW 812 transfers an HTTP request with an application ID to UE 401 over the IP network and WIFI AN 402. UE 401 transfers hardware IDs and software IDs in an HTTP response to IWF SW 812 over WIFI AN 402 and the IP network. IWF SW 812 transfers the hardware IDs and software IDs to DL SW 819. DL SW 819 informs IWF SW 812 that UE 401 is authenticated and authorized for service. IWF SW 812 signals AMF SW 813 that UE 401 is authenticated and authorized for service.

In some examples, AMF SW 813 receives an access request from UE 401 over 5GNR AN 411—possibly in an initial UE message or NAS message. In response to the access request, AMF SW 813 transfers an HTTP request having an application ID to UE 401 over 5GNR AN 411—possibly in a NAS message. AMF SW 813 receives hardware IDs and software IDs from UE 401 over 5GNR AN 411—possibly in an HTTP response that is transported by a NAS message. AMF SW 813 transfers the hardware IDs and software IDs to UDM 414. When UDM SW 814 signals AMF SW 813 that UE 401 is authenticated and authorized, AMF SW 813 establishes a data session for UE 401. AMF SW 813 may retrieve UE context for UE 401 from UDM SW 814 and transfer the UE context to SMF SW 815 for additional context development. AMF SW 813 transfers the UE context to 5GNR AN 411. AMF SW 813 may establish an N1 link with UE 401 over 5GNR AN 413 and exchange data messages with UE 401 over the N1 link. AMF SW 813 may exchange these data messages with AS 421 over NEF SW 817 and AF SW 818.

In some examples, AMF SW 813 receives the access request from UE 401 over WIFI AN 402, the IP network, and IWF SW 812—possibly in an HTTP message that is transported by a NAS message. In response to the access request, AMF 413 transfers an HTTP request with an application ID to UE 401 over IWF SW 812, the IP network, and WIFI AN 402. UE 401 transfers the hardware IDs and software IDs in an HTTP response to AMF SW 813 over WIFI AN 402, the IP network, and IWF SW 812. AMF SW 813 transfers the hardware IDs and software IDs to UDM SW 814. When UDM SW 814 signals AMF SW 813 that UE 401 is authenticated and authorized, AMF SW 813 establishes a data session for UE 401. To establish the data session, AMF SW 813 may retrieve UE context for UE 401 from UDM SW 814 and transfer the UE context to SMF 415 for additional context development. AMF SW 813 transfers the UE context to IWF SW 812. SMF SW 815 transfers the UE context to UPF SW 816. UE 401 may then communicate with AS 422 over WIFI AN 402, the IP network, IWF SW 812, and UPF SW 816. AMF SW 813 may establish an N1 link with UE 401 over IWF SW 812, the IP network, and WIFI AN 402 and exchange data messages with UE 401 over the N1 link. AMF SW 813 may exchange these data messages with AS 421 over NEF SW 817 and AF SW 818.

In some examples, 5GNR AN 411 signals AMF SW 813 that UE 401 is authenticated and authorized for service, and AMF SW 813 establishes a data session for UE 401. In some examples, WIFI AN 402 signals IWF SW 812 that UE 401 is authenticated and authorized for service, and IWF SW 812 signals the same to AMF SW 813. AMF SW 813 may then establish a data session for UE 401.

In some examples, UDM SW 814 authenticates and authorizes UE 401 based on the hardware IDs and software IDs. For example, UDM SW 814 may compare the hardware IDs and software IDs to known values for these IDs that are maintained in 3GPP network 410. In a similar manner, UDM SW 814 may authenticate and authorize UE 401 based on resource states and a random number in addition to the hardware IDs and software IDs. UDM SW 814 may be configured with a distributed ledger node and authenticate and authorize UE 401 in the manner of DL SW 819. UDM SW 814 instructs AMF SW 813 that UE 401 is authenticated and authorized for service.

In some examples, WIFI AN 402, 5GNR AN 411, or IWF SW 812 transfer the hardware IDs and software IDs to DL SW 819. DL SW 819 executes a smart contract with the hardware IDs and software IDs to authenticate and authorize UE 401. For example, DL SW 819 may compare the hardware IDs and software IDs to known values for these IDs that are maintained in DL SW 819. In a similar manner, DL SW 819 may authenticate and authorize UE 401 based on resource states and a random number in addition to the hardware IDs and software IDs. DL SW 819 reaches a consensus on the authentication and authorization and instructs IWF SW 812, WIFI AN 402, or 5GNR AN 411 that UE 401 is authenticated and authorized for service.

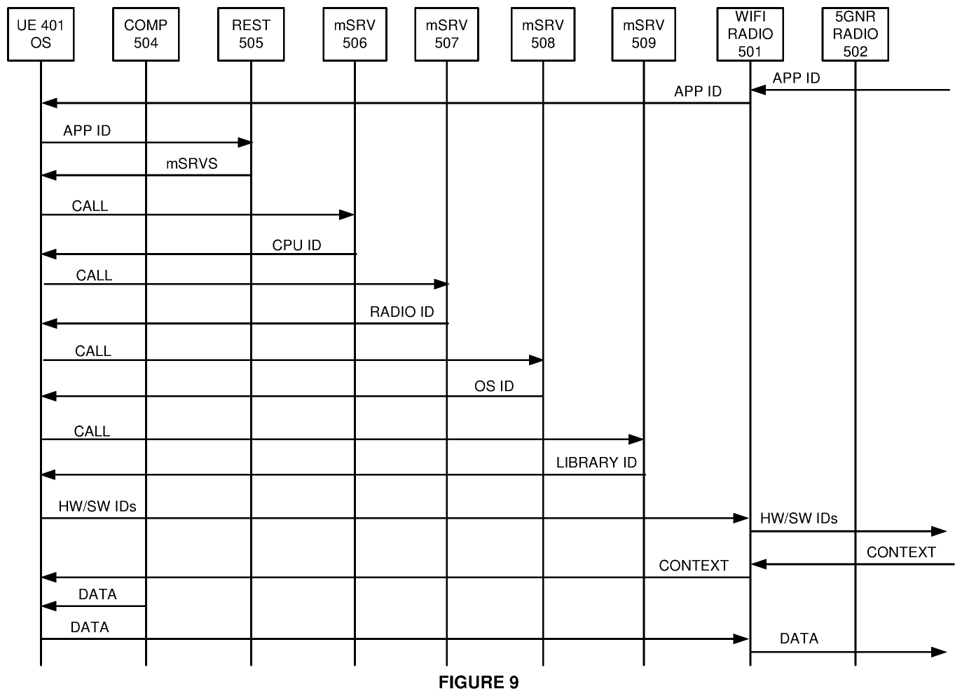

FIG. 9 illustrates an exemplary operation of wireless UE 401 to obtain access to 3GPP network 410. The operation may vary in other examples. WIFI radio circuitry 501 receives an HTTP request from AMF 413 (not shown) that includes an app ID and transfers the HTTP request with the app ID to the operating system in processing circuitry 503 of UE 401 (UE 401 OS). The UE 401 OS calls REST API 505 (REST 505) with the app ID in response to the HTTP request. REST API 505 translates the app ID into microservice APIs 506-509 (mSRV 506-509) by using a local data structure and indicates microservice APIs 506-509 to the UE 401 OS.

The UE 401 OS calls microservice API 506, and in response, microservice API 506 retrieves the CPU ID for processing circuitry 503 from a local data structure and indicates the CPU ID to the UE 401 OS. The UE 401 OS calls microservice API 507, and in response, microservice API 507 retrieves the radio ID for radio circuitry 501 and/or 502 from a local data structure and indicates the radio ID to the UE 401 OS. The UE 401 OS calls microservice API 508, and in response, microservice API 508 retrieves an operating system ID from a local data structure and indicates the operating system ID to the UE 401 OS. The UE 401 OS calls microservice API 508, and in response, microservice API 509 retrieves a software library ID for from a local data structure and indicates the software library ID to the UE 401 OS. UE 401 OS may obtain resource states and random numbers from other microservice APIs in a similar manner. The UE 401 OS transfers the CPU ID, radio ID, operating system, and library ID to WIFI radio circuitry 501 in an HTTP response—possibly transported by a NAS message. The UE 401 OS may encrypt the HTTP response with a public key for 3GPP network 410. WIFI radio circuitry 501 transfers the HTTP response to AMF 413 (not shown) with the CPU ID, radio ID, operating system ID, and software library ID.

After UE 401 is authenticated and authorized (not shown on FIG. 9), WIFI radio 501 receives UE context from AMF 413 (not shown) and transfers the UE context to the UE 401 OS. The UE 401 OS receives data from components 504 like environmental metrics, medical readings, photographs, or some other information. The UE 401 OS transfers the data to WIFI radio circuitry 501. WIFI radio circuitry 501 transfers the data to WIFI AN 402 (not shown). In alternative other examples, 5GNR radio circuitry 502 may be used for authentication, authorization, and data exchange in the manner of WIFI radio circuitry 501.

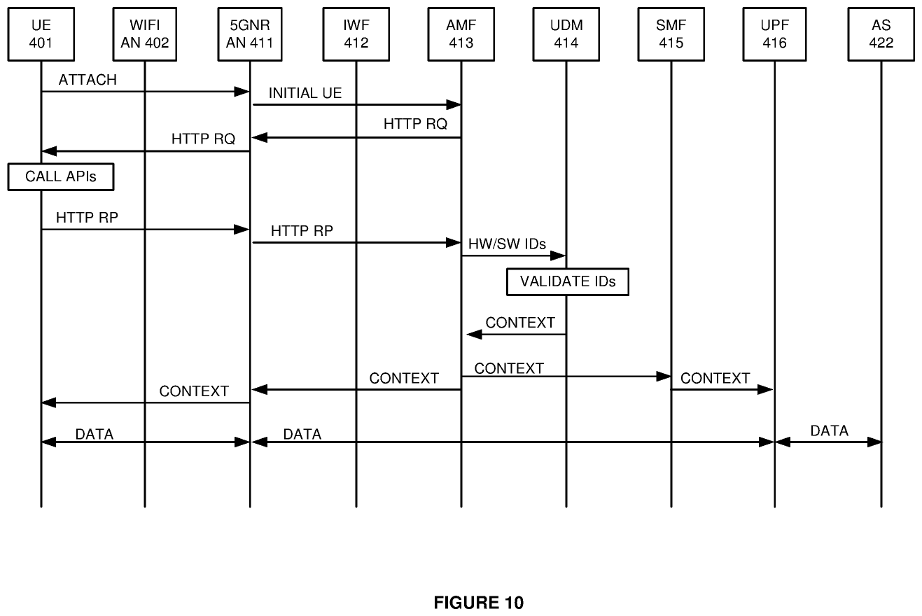

FIG. 10 illustrates an exemplary operation of wireless communication system 400 that has wireless UE 401 which obtains access to 3GPP network 410. The operation may vary in other examples. UE 401 wirelessly attaches to 5GNR AN 411. In response, 5GNR AN 411 transfers an initial UE message to AMF 413. In response to the initial UE message, AMF 413 transfers an NAS message that transports an HTTP request (RQ) that has an application ID to 5GNR AN 411. 5GNR AN 411 transfers the NAS message that transports the HTTP request having the application ID to UE 401. In response to the HTTP request, UE 401 calls REST API 505 with the application ID to obtain microservice APIs 506-509. UE 401 calls microservice APIs 506-509 to obtain hardware IDs and software IDs. UE 401 transfers the hardware IDs and software IDs to 5GNR AN 411 in a NAS message that transports an HTTP response (RP) that has the IDs. 5GNR AN 411 transfers the NAS message that transports the HTTP response that has the IDs to AMF 413. AMF 413 transfers the hardware (HW) IDs and software (SW) IDs to UDM 414. UDM 414 authenticates and authorizes UE 401 based on the hardware IDs and software IDs. For example, UDM 414 may compare the hardware IDs and software IDs to known values for these IDs that are maintained by UDM 414 for UE 401. UDM 414 transfers UE context for a data session to AMF 413 when UE 401 is authenticated and authorized. AMF 413 transfers the UE context to SMF 415 for additional context development. SMF 415 transfers the UE context to UPF 416. AMF 413 transfers the UE context to 5GNR AN 411. 5GNR AN 411 transfers the UE context to UE 401. UE 401 exchanges data with AS 422 over 5GNR AN 411 and UPF 416.

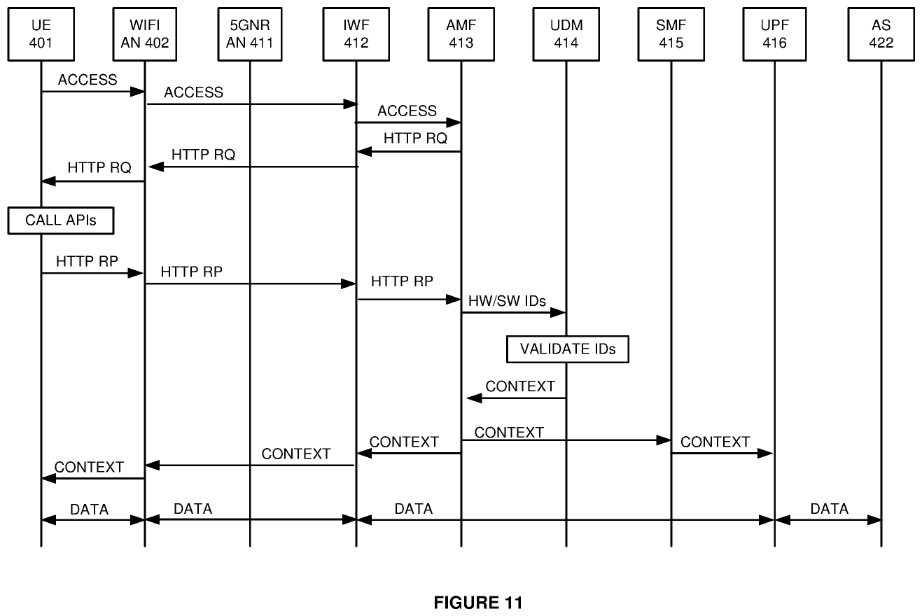

FIG. 11 illustrates an exemplary operation of wireless communication system 400 that has wireless UE 401 which obtains access to 3GPP network 410. UE 401 transfers an access request to AMF 413 over WIFI AN 402 and IWF 412. In response to the access request, AMF 413 transfers an HTTP request with an application ID to UE 401 over IWF 412 and WIFI AN 402. In response to the HTTP request, UE 401 calls a REST API with the application ID. The REST API returns various microservice APIs. UE 401 calls the microservice APIs, and the microservice APIs return hardware IDs and software IDs. UE 401 transfers the hardware IDs and software IDs in an HTTP response to AMF 413 over WIFI AN 402 and IWF 412. AMF 413 transfers the hardware IDs and software IDs to UDM 414. UDM 414 authenticates and authorizes UE 401 based on the hardware IDs and software IDs. UDM 414 transfers UE context for UE 401 to AMF 413. AMF 413 transfers the UE context to SMF 415 for additional context development. SMF 415 transfers the UE context to UPF 416. AMF 413 transfers the UE context to IWF 412. IWF 412 transfers the UE context to UE 401 over WIFI AN 402. UE 401 communicates with AS 422 over WIFI AN 402, IWF 412, and UPF 416.

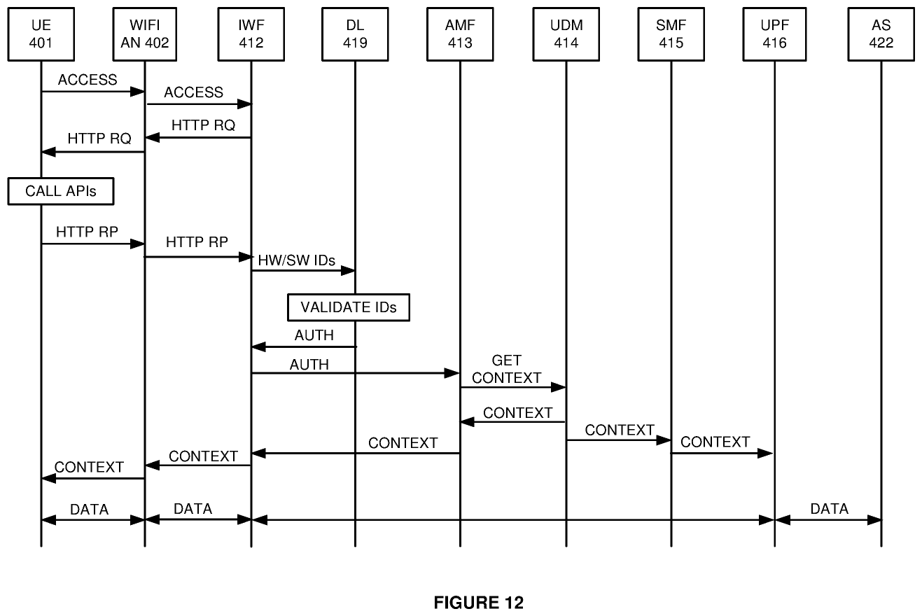

FIG. 12 illustrates an exemplary operation of wireless communication system 400 that has wireless UE 401 which obtains access to IWF 412. UE 401 transfers an access request to IWF 412 over WIFI AN 402. In response to the access request, IWF 412 transfers an HTTP request with an application ID to UE 401 over WIFI AN 402. In response to the HTTP request, UE 401 calls a REST API with the application ID. The REST API returns various microservice APIs. UE 401 calls the microservice APIs, and the microservice APIs return hardware IDs and software IDs. UE 401 transfers the hardware IDs and software IDs in an HTTP response to IWF 412 over WIFI AN 402. IWF 412 transfers the hardware IDs and software IDs to DL 419. DL 419 executes a smart contract with the hardware IDs and software IDs to authenticate and authorize UE 401. DL 419 reaches a consensus on the authentication and authorization and instructs IWF 412 that UE 401 is authenticated and authorized for service (AUTH). IWF 412 then signals AMF 413 that UE 401 is authenticated and authorized for service. AMF 413 gets UE context for UE 401 from UDM 414. AMF 413 transfers the UE context to SMF 415 for additional context development. SMF 415 transfers the UE context to UPF 416. AMF 413 transfers the UE context to IWF 412. IWF 412 transfers the UE context to UE 401 over WIFI AN 402. UE 402 communicates with AS 422 over WIFI AN 402, IWF 412, and UPF 416.

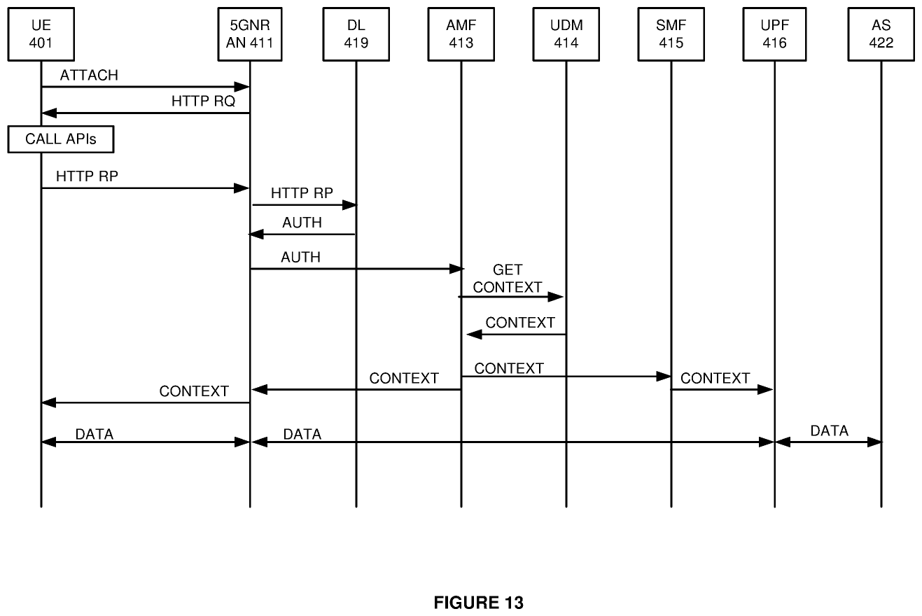

FIG. 13 illustrates an exemplary operation of wireless communication system 400 that has wireless UE 401 which obtains access to 3GPP network 410. UE 401 attaches to 5GNR AN 411. In response to the access request, 5GNR AN 411 transfers an HTTP request with an application ID to UE 401. In response to the HTTP request, UE 401 calls a REST API with the application ID. The REST API returns various microservice APIs. UE 401 calls the microservice APIs, and the microservice APIs return hardware IDs and software IDs. UE 401 transfers the hardware IDs and software IDs to 5GNR AN 411 in an HTTP response. 5GNR AN 411 transfers the HTTP response to DL 419. DL 419 executes a smart contract with the hardware IDs and software IDs to authenticate and authorize UE 401. DL 419 reaches a consensus on the authentication and authorization and instructs 5GNR AN 411 that UE 401 is authenticated and authorized for service (AUTH). 5GNR AN 411 then signals AMF 413 that UE 401 is authenticated and authorized for service. AMF 413 retrieves UE context for UE 401 from UDM 414. AMF 413 transfers the UE context to SMF 415 for additional context development. SMF 415 transfers the UE context to UPF 416. AMF 413 transfers the UE context to 5GNR AN 411. 5GNR AN 411 transfers the UE context to UE 401. UE 401 communicates with AS 422 over 5GNR AN 411 and UPF 416.

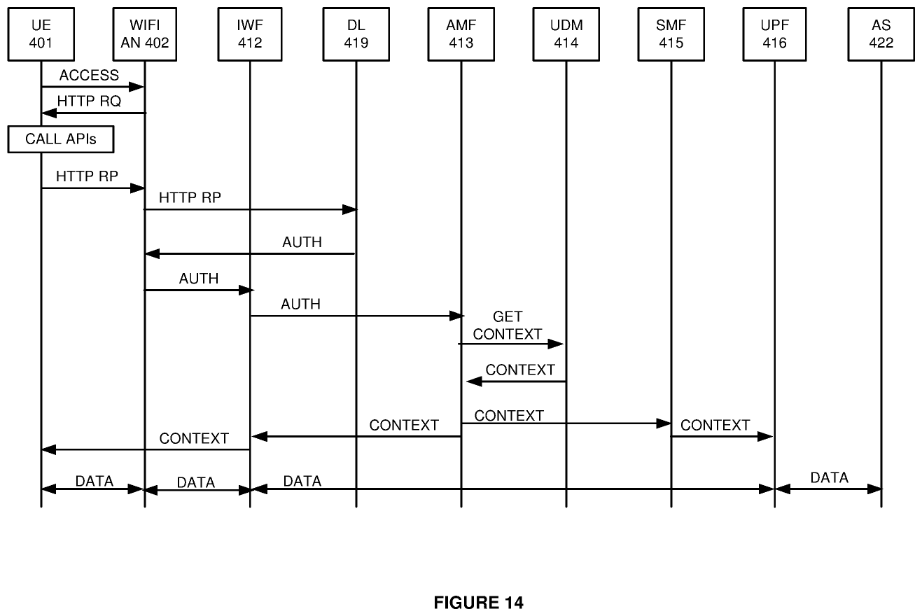

FIG. 14 illustrates an exemplary operation of wireless communication system 400 that has wireless UE 401 which obtains access to IWF 412. UE 401 transfers an access request to WIFI AN 402. In response to the access request, WIFI AN 402 transfers an HTTP request with an application ID to UE 401. In response to the HTTP request, UE 401 calls a REST API with the application ID. The REST API returns various microservice APIs. UE 401 calls the microservice APIs, and the microservice APIs return hardware IDs and software IDs. UE 401 transfers the hardware IDs and software IDs in an HTTP response to WIFI AN 402. WIFI AN 402 transfers the hardware IDs and software IDs to DL 419. DL 419 executes a smart contract with the hardware IDs and software IDs to authenticate and authorize UE 401. DL 419 reaches a consensus on the authentication and authorization and instructs WIFI AN 402 that UE 401 is authenticated and authorized for service (AUTH). WIFI AN 402 signals IWF 412 that UE 401 is authenticated and authorized for service. IWF 412 signals AMF 413 that UE 401 is authenticated and authorized for service. AMF 413 retrieves UE context for UE 401 from UDM 414. AMF 413 transfers the UE context to SMF 415 for additional context development. SMF 415 transfers the UE context to UPF 416. AMF 413 transfers the UE context to IWF 412. IWF 412 transfers the UE context to UE 401 over WIFI AN 402. UE 401 communicates with AS 422 over WIFI AN 402, IWF 412, and UPF 416.

The wireless communication system circuitry described above comprises computer hardware and software that form special-purpose wireless communication device circuitry to obtain access to a wireless communication network. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose wireless communication device circuitry to obtain access to a wireless communication network.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method to access a wireless communication network, the method comprising:
identifying an application identifier;
calling a device Application Programming Interface (API) with the application identifier to identify a microservice API;
calling the microservice API to identify a hardware identifier; and
transferring the hardware identifier to obtain access to the wireless communication network.

2. The method of claim 1 wherein:
calling the microservice API to identify the hardware identifier comprises calling the microservice API to identify a manufacturer device identifier; and
transferring the hardware identifier to obtain access to the wireless communication network comprises transferring the manufacturer device identifier to obtain the access to the wireless communication network.

3. The method of claim 1 wherein:
calling the microservice API to identify the hardware identifier comprises calling the microservice API to identify a processing circuitry identifier; and
transferring the hardware identifier to obtain access to the wireless communication network comprises transferring the processing circuitry identifier to obtain the access to the wireless communication network.

4. The method of claim 1 wherein:
calling the microservice API to identify the hardware identifier comprises calling the microservice API to identify a radio circuitry identifier; and
transferring the hardware identifier to obtain access to the wireless communication network comprises transferring the radio circuitry identifier to obtain the access to the wireless communication network.

5. The method of claim 1 wherein:
calling the device API with the application identifier to identify the microservice API comprises calling the device API with the application identifier to identify the microservice API and another microservice API; and further comprising
calling the other microservice API to identify a software identifier; and wherein
transferring the hardware identifier to obtain access to the wireless communication network comprises transferring the hardware identifier and the software identifier to obtain access to the wireless communication network.

6. The method of claim 1 wherein:
calling the device API with the application identifier to identify the microservice API comprises calling the device API with the application identifier to identify the microservice API and another microservice API; and further comprising
calling the other microservice API to identify an operating system identifier; and wherein
transferring the hardware identifier to obtain access to the wireless communication network comprises transferring the hardware identifier and the operating system identifier to obtain the access to the wireless communication network.

7. The method of claim 1 wherein:
calling the device API with the application identifier to identify the microservice API comprises calling the device API with the application identifier to identify the microservice API and another microservice API; and further comprising
calling the other microservice API to identify a software library identifier; and wherein
transferring the hardware identifier to obtain access to the wireless communication network comprises transferring the hardware identifier and the software library identifier to obtain the access to the wireless communication network.

8. A method of operating a wireless communication device to access a wireless communication network, the method comprising:
radio circuitry wirelessly receiving an application identifier;
processing circuitry calling a Representation State Transfer (REST) Application Programming Interface (API) with the application identifier to identify a microservice API;
the processing circuitry calling the microservice API to identify a hardware identifier; and
the radio circuitry wirelessly transferring the hardware identifier to obtain access to the wireless communication network.

9. The method of claim 8 wherein:
the processing circuitry calling the microservice API to identify the hardware identifier comprises the processing circuitry calling the microservice API to identify a wireless communication device manufacturer device identifier; and
the radio circuitry wirelessly transferring the hardware identifier to obtain the access to the wireless communication network comprises the radio circuitry wirelessly transferring the wireless communication device manufacturer device identifier to obtain the access to the wireless communication network.

10. The method of claim 8 wherein:
the processing circuitry calling the microservice API to identify the hardware identifier comprises the processing circuitry calling the microservice API to identify a processing circuitry identifier; and
the radio circuitry wirelessly transferring the hardware identifier to obtain the access to the wireless communication network comprises the radio circuitry wirelessly transferring the processing circuitry identifier to obtain the access to the wireless communication network.

11. The method of claim 8 wherein:
the processing circuitry calling the microservice API to identify the hardware identifier comprises the processing circuitry calling the microservice API to identify a radio circuitry identifier; and
the radio circuitry wirelessly transferring the hardware identifier to obtain the access to the wireless communication network comprises the radio circuitry wirelessly transferring the radio circuitry identifier to obtain the access to the wireless communication network.

12. The method of claim 8 wherein:
the processing circuitry calling the REST API with the application identifier to identify the microservice API comprises the processing circuitry calling the REST API with the application identifier to identify the microservice API and another microservice API; and further comprising
the processing circuitry calling the other microservice API to identify a software identifier; and wherein
the radio circuitry wirelessly transferring the hardware identifier to obtain the access to the wireless communication network comprises the radio circuitry wirelessly transferring the hardware identifier and the software identifier to obtain the access to the wireless communication network.

13. The method of claim 8 wherein:
the processing circuitry calling the REST API with the application identifier to identify the microservice API comprises the processing circuitry calling the REST API with the application identifier to identify the microservice API and another microservice API; and further comprising
the processing circuitry calling the other microservice API to identify an operating system identifier; and wherein
the radio circuitry wirelessly transferring the hardware identifier to obtain the access to the wireless communication network comprises the radio circuitry wirelessly transferring the hardware identifier and the operating system identifier to obtain the access to the wireless communication network.

14. The method of claim 8 wherein:
the processing circuitry calling the REST API with the application identifier to identify the microservice API comprises the processing circuitry calling the REST API with the application identifier to identify the microservice API and another microservice API; and further comprising
the processing circuitry calling the other microservice API to identify a software library identifier; and wherein
the radio circuitry wirelessly transferring the hardware identifier to obtain the access to the wireless communication network comprises the radio circuitry wirelessly transferring the hardware identifier and the software library identifier to obtain the access to the wireless communication network.

15. A wireless communication device to access a wireless communication network, the wireless communication device comprising:
radio circuitry to wirelessly receive a Hypertext Transfer Protocol (HTTP) request that indicates an application identifier;
processing circuitry to call a Representation State Transfer (REST) Application Programming Interface (API) with the application identifier to identify a microservice API;
the processing circuitry to call the microservice API to identify a hardware identifier; and
the radio circuitry to wirelessly transfer an HTTP response that indicates the hardware identifier to obtain access to the wireless communication network.

16. The wireless communication device of claim 15 wherein:
the processing circuitry is to call the microservice API to identify a wireless communication device manufacturer device identifier; and
the radio circuitry is to wirelessly transfer the wireless communication device manufacturer device identifier to obtain access to the wireless communication network.

17. The wireless communication device of claim 15 wherein:
the processing circuitry is to call the microservice API to identify a processing circuitry identifier; and
the radio circuitry is to wirelessly transfer the processing circuitry identifier to obtain access to the wireless communication network.

18. The wireless communication device of claim 15 wherein:
the processing circuitry is to call the microservice API to identify a radio circuitry identifier; and
the radio circuitry is to wirelessly transfer the radio circuitry identifier to obtain access to the wireless communication network.

19. The wireless communication device of claim 15 wherein:
the processing circuitry is to call the REST API with the application identifier to identify the microservice API and another microservice API; and further comprising
the processing circuitry to call the other microservice API to identify a software identifier; and wherein
the radio circuitry is to wirelessly transfer the hardware identifier and the software identifier to obtain access to the wireless communication network.

20. The wireless communication device of claim 15 wherein:
the processing circuitry is to call the REST API with the application identifier to identify the microservice API and another microservice API; and further comprising
the processing circuitry to call the other microservice API to identify at least one of an operating system identifier and a software library identifier; and wherein
the radio circuitry is to wirelessly transfer the hardware identifier and the at least one of the operating system identifier and the software library identifier to obtain access to the wireless communication network.
